(19) United States
(12) Patent Application Publication
(10) Pub. No.: US 2025/0170658 A1
(43) Pub. Date: May 29, 2025

(54) System and Method for Tube Notching

(71) Applicant: Joseph Gambino, Sandy, OR (US)

(72) Inventor: Joseph Gambino, Sandy, OR (US)

(21) Appl. No.: 18/520,911

(22) Filed: Nov. 28, 2023

(51) Int. Cl. B23B 47/28; B25B 5/14

(52) U.S. Cl. CPC B23B 47/281; B25B 5/147; B23B 2247/12

(57) ABSTRACT

The design of the vise mechanism in this Tube Notching Device increases capabilities to position the cutting tool relative to the feedstock. This device holds feedstock, centering the feedstock latitudinally and longitudinally to the cutting bit allowing cuts to be reproduced true to each other due to the design of the vise mechanism. Existing tube notching devices allow for the cutting tool to be pivoted relative to the feedstock in one axis, and have vices that only center in one axis. The effectiveness of this tube notching device is increased by the ability of the cutting tool to both translate in one direction and pivot in 2 axes relative to the feedstock, as well as have a vice that can canter feedstock horizontally and vertically. This increased adjustability allows the vise and cutting head to be closer together, which increases safety, operator comfort, and cutting bit life.

### PRIOR ART

Prior art patent filings related to tube notchers include U.S. patent numbers U.S. Pat. No. 8,152,419, US20090022559A1, US20120243954A1, US20150139774A1, and US20230088748A1. The complete disclosures of the above patents are herein incorporated by reference for all purposes.

### BACKGROUND OF THE INVENTION

The present disclosure invention relates to auto centering material in a clamp to be cut with accuracy and precision with respect to the centerline of the material to be cut. In particular, a tube notching device that contains an adjustable jaw clamp that maintains the centerline of material to be cut.

Tube notchers are devices that allow separate cylindrical shaped material (such as tubes or rods) to be coped together. Having a precise cope on tubes to be joined is essential for efficient and structurally sound joining of material. When a material such as a tube is cut using a circular cutting bit, the resultant cut out shape in the material cut is a 3-dimensional curve; namely a curve that may be seem from either direction as having character of curvature.

Existing tube notchers do not fully take into account the relationship between the alignment of center of the cutting bit with respect to the centerline of the feedstock. The centerline of the cutting die and the centerline of the feedstock must be in alignment for accurate cutting of a true cope.

Consequently, a need exists that enables workers to be able to securely and quickly make custom notched tubes.

An additional requisite of tube notches is their ability to securely hold the work piece. While some existing tube notchers have the ability to secure the feedstock to the tubing notcher, none exist that secure both cylindrical and rectangular with sufficient safety. Different clamping mechanisms have been proposed, however none to date satisfy this safety requirement while maintaining alignment of centerlines of feedstock and the cutting tool.

The design of this device allows it to be used fixed to a workbench, or as a tool on location, in-situ. Where larger tubes or tubes that are affixed to a structure are being notched, this device can be attached to the tube that is being cut without being fixed in another holding device (such as a vice affixed to a workbench).

### BRIEF DESCRIPTION OF THE DRAWINGS

FIG. 1. Represents a side view where the adjustment drive screw 104 is parallel to the plane of the page as well as the plane of the workbench.

FIG. 2. Shows the disclosed device 180 degrees rotated about 2 axes; the Y axis as well the axis perpendicular to the page, yet still parallel to the work bench.

FIG. 3. Illustrates how the cutting bit is on an angle incident to a curved tube section.

FIG. 4. Shows the resultant notch side cut in a curved section of tube.

FIG. 5. Illustrates the device's ability to notch existing tube that is fixed in place where the device is not mounted to a workbench but clamped onto the feedstock as a free-standing tool.

### SUMMARY OF THE INVENTION

The work presented here intends to make plain the apparatus that holds the feedstock in position in a tube notcher device, and centers the feedstock latitudinally and longitudinally to the cutting bit, such that work flow cuts can be reproduced true to each other and with a minimum degree of variation from piece to piece. Further, feedstocks of different dimensions and geometry may be fed into the device while maintaining the latitude and longitude with respect to the cutting bit, aligning the center line of the work flow piece to the cutting bit centerline.

### BACKGROUND

With reference to the figures, tube notching devices will now be described. The tube notching devices discussed herein function to form notches in feedstocks, including tubular feedstocks. Additionally, or alternatively to tubular feedstocks, the tube notching devices are configured to form notches in bars, rods, plates, and structural members.

The reader will appreciate from the figures and description below that the presently disclosed tube notching devices address many of the shortcomings of conventional tube notching devices. For example, the tube notching devices described herein provide increased capabilities to position the cutting tool relative to the feedstock. In addition to allowing for the cutting tool to be translated relative to the feedstock, the present tube notching devices also allow for the cutting tool to be pivoted relative to the feedstock. The notching effectiveness of the tube notching devices described in this document is increased by their ability to both translate and pivot the cutting tool relative to the feedstock. Advantageously, the tube notching devices described herein allow the cutting tool to be kept closer to the bearing block, which increases safety, operator comfort, and cutting bit life.

The present tube notching devices are more stable than conventional tube notching devices. The tube notching devices described herein include two pivots to reduce or eliminate the cutting tool deviating from a desired orientation relative to the feedstock as the tool is used. Improving over existing tube notching devices, the present tube notching devices hold the cutting tool in a desired orientation more rigidly and securely. In particular, they include a second pivot that can secure the cutting tool in a desired orientation in cooperation with a first pivot. Further enhancing the rigidity and stability of the tube notching devices over conventional devices, the first and second pivots are disposed outside the cutting area.

### CONTEXTUAL DETAILS

Ancillary features relevant to the tube notching devices described herein will first be described to provide context and to aid the discussion of the tube notching devices.

### Definitions

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components.

### DETAILED DESCRIPTION OF THE INVENTION

The disclosed tube notcher clamping mechanism is better understood through a close examination of the figures and accompanying descriptions herein. The examples provided intend to exemplify certain examples of the disclosed device but are not considered an exhaustive description, for many variations of the disclosed device not described here apply.

Those skilled in the art will understand that many variations, alterations, and modifications of the examples provided herein may occur without a departing from the scope of the work presented here. The variations referred to here will not be displayed, discussed or illustrated for the sake of brevity.

To complete the picture of the disclosed device, examples of various tube notchers are provided. Related forms and functions may or may not be similar to other examples presented.

### Feedstock

The feedstock on which the tube notching devices described herein may work may be any feedstock suitable for being held in place and cut with a cutting mechanism. In the examples shown in the figures, the feedstock is tubular to define a tubular feedstock 102. Additionally, or alternatively to tubular feedstocks, the feedstock may be a bar, rod, plate, or structural member. For the sake of brevity, all material types being cut will be referred to as “tube”, “tubing”, or “feedstock”. In some of the disclosed figures, the feedstock is represented as a hollow cylindrical shape (representing a tubular feedstock, 109).

### Tube Notching Devices

With reference to the figures, tube notching devices will now be described. The tube notching devices discussed herein function to form notches in feedstocks, including tubular feedstocks. Additionally, or alternatively to tubular feedstocks, the tube notching devices are configured to form notches in bars, rods, plates, and structural members. In each of the figures, a “Y” direction is illustrated indicating the “top” of the device.

### Desired Notch

The tube notching device is designed to cut a notch in a desired feedstock, wherein the feedstock has the shape or shapes as described above. The notch that is cut into the feedstock also varies in its size and position with respect to the rest of the piece of feedstock. There may be more than one notch in any given piece of feedstock.

### Vise

Essential to the design, function and safety of the tube notcher disclosed is the vise that holds the feedstock in position.

The feedstock is held in position with respect to the cutting bit such that the feedstock to be cut is centered on the center axis of the bit both vertically and horizontally. It is essential that the alignment of the axes remains centered to ensure a true cut. A true cut is one that accurately reflects the intention of the worker to form a feedstock to suit the intended application of the piece cut. Often, a symmetrical cut on the feedstock is desired. Changing the feedstock dimensions or shape will require the axes of the feedstock and the bit to be realigned.

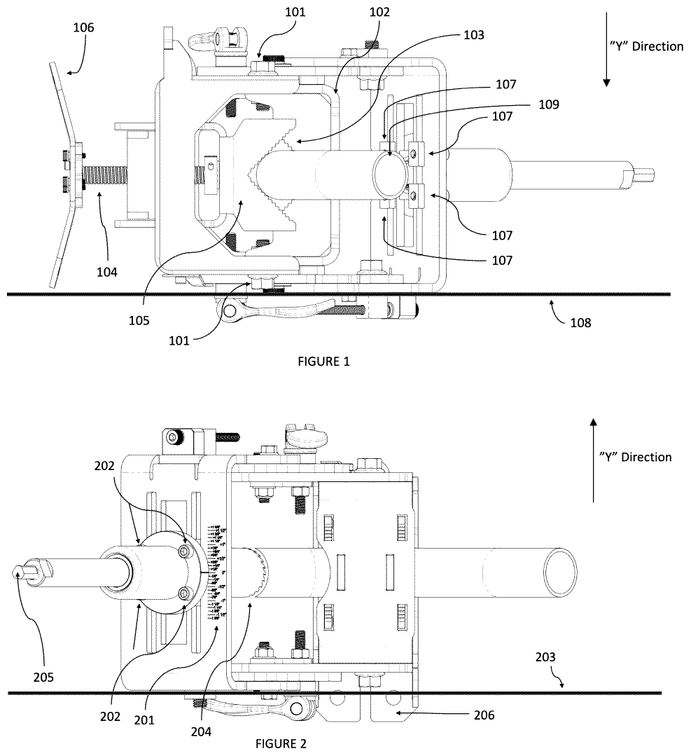

Without complicated measurement and use of additional jigs to support either the cutting bit or feedstock, the feedstock clamp (shown in FIGS. 1, 105 and 106) allows for the centerline axis of the feedstock parallel to the base plane, FIG. 1, 108 (imposed on the drawing for reference points to be drawn to of the tube notcher components) be aligned quickly and without unnecessary additional complication. Loosening nuts 101 allow the static jaw to translate left or right with respect to the centerline of the feedstock (parallel to 108). This enables an alignment of feedstock centerline to the cutting bit centerline longitudinally. Once the static jaw is in the required position, the dynamic jaw 105 is secured to feedstock by the adjustment drive screw 104 by turning dynamic jaw adjustment lever 106. Notice that the adjustment of the static jaw and the dynamic jaw are not required to be adjusted in this order; the dynamic jaw may be adjusted first, depending on the needs of the operator. Note that this opposable, dynamic gripping vise offers alignment of feedstock and cutting bit that is unique. FIG. 1 also discloses a removeable handle (106) to free up space in the working environment if the task requires such.

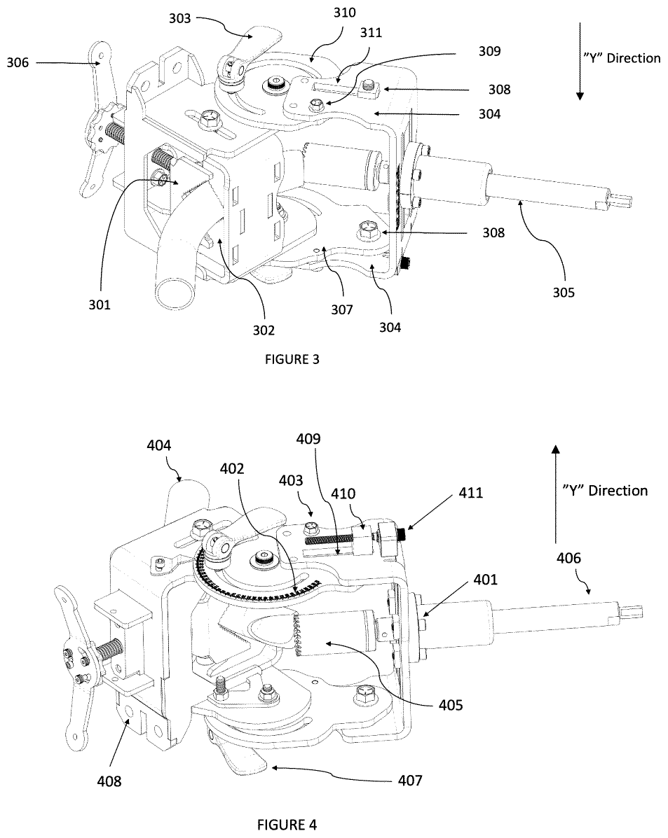

FIG. 3. The gripping vise jaws heretofore described both have 90-degree angles between their feedstock contact surfaces (301 and 302). These enable the gripping part of the vise, sometimes referred to as “jaws”, or “gripping jaws” to grab corners and flats on square or rectangular or flat material. This improves safety for the feedstock is securely held in place when the operator performs the desired cut. Other designs have the possibility to come loose in a vice of different design while cutting with the cutting bit imposing unnecessary danger to the operator and tool.

FIG. 3 describes a handle (306) that is removeable. This design feature allows for setting the angle on the machine cutting head frame (304) at angles that would interfere with handle (306) if it were in place.

FIG. 3 discloses an adjustable primary frame member (310) that may be adjusted and locked into position by adjustment handle (303) allowing the user to change the angle of incidence of the cutting bit (305) to the feedstock for various cut angles. Also shown is a shaft (305) which is driven by a drill or other rotary drive and terminates in standard hole saw threading is used so that any off the shelf hole saw will fit.

There is a need in many notching applications for adjusting the driveshaft as heretofore disclosed, it is necessary to adjust the centerline axis of the cutting bit, (FIG. 2, 204). The offset adjustment scale (FIG. 2, 201) allows the cutting bit axis to be changed vertically, that is, perpendicular to the base line (203) of the unit. In FIG. 2, the four adjustment screws shown as 202 may be loosened allowing the cutting bit drive shaft to translate up and down, allowing for accurate and precise offset adjustment, as the needs of the operator and the task at hand dictate. Feature 202 is a set of 4 bolts that locks the vertical offset which allows precise notching of a feedstock with a bend previously worked into the piece being notched. FIG. 2, 206 illustrates part of the device disclosing a pattern of hardware that enables the user to quickly and safely mount the device to an array of any preexisting mounting fixtures that are fixed to any work table support stand. This pattern of hardware lends an extra level of safety and affordability, for no specialty hardware is required for securing the device to a stable work platform.

Additional adjustments can be made to accommodate flexibility in notching tube. FIG. 3 illustrates an extension adjustment secured by bolts passed through slots to (FIG. 3, 308) to allow further refinement of the incident cutting angle by extending the cutting blade frame (304) to move closer or further away from the feedstock to be cut. Changing the angle of the frame which contains the notcher shaft (305) allows the frame (304) a secondary pivot point (about the axis of 308). This translation and pivot about (308) may be simultaneously locked with (309) when not needed. Making adjustments using this feature allows the user to quickly accommodate different diameter feedstock as well as greater options for angle of incidence of cutting blade to feedstock. The frame can extend (304 moves away from plates 307 and 310 in mounting slots). This can allow odd shaped material to be notched when cuts must be farther from the vise clamping area. Additionally, this is a substantial benefit when the user wants to use longer cutting tools (like deep cutting hole saws). Longer hole saws allow shallower cut angles measured from the axis of the cutting tool to the center axis of the tubing being cut. Shallow cuts are very time consuming with short cutting tools. By adjusting the handle seen in FIG. 3, 303, the frame may be further adjusted allowing a total of 120 degrees of overtravel to feed tube notcher from the side opposite the cutting bit allowing more versatility to cuts that can be made as well as ensuring worker safety. The frame section (304) holding the bearing block extends by means of a slot feature (311) which is described by parallel sides and ability to translate in frame components (307 and 310). This ability to translate into frame component reduces the number of components required to control rotation of the bearing block (via frame section 304) to the minimum possible (only 2). This feature facilitates minimal the manufacturing variation of the parts. The designed gaps between them dictate that they vary by the lowest possible angles. This provides value in reducing the manufacturing cost of a readable position/offset scale while increasing accuracy of the device.

FIG. 4 illustrates a fine adjustment knob (401). This serves to allow the (feedstock in vice) to be precisely matched in angle to the cutting bit by fine tuning the angle of incidence onto the material being cut. Due to the range of adjustment within this device in slots 409, it is possible for the user to introduce rotation or “sag” where the cutting head moves downward in the Y direction. This fine adjustment (401) allows the user to precisely counteract that rotation. This is done when a cut is being set up in the device and while the offset adjustment bolts (401) are unlocked and the offset is driven by adjustment (411) in slot (409). Locking the hardware (401) locks this setting. This fine adjustment knob 411 functions in coordination with the adjustable opposing jaw in the vise assembly, as they each provide adjustment that serve to center the feedstock relative to the cutting head in perpendicular axes. This is paramount to enabling a user to be able to precisely align cutting bits with feedstocks in a variety of situations. Tools without methods to align in the “Y” axis direction and the axis perpendicular to “Y” are vastly more difficult (or impossible) to cut on feedstock centerline. Various lengths of cutting bit (405) may be accommodated to cut through feedstock of varying diameters.

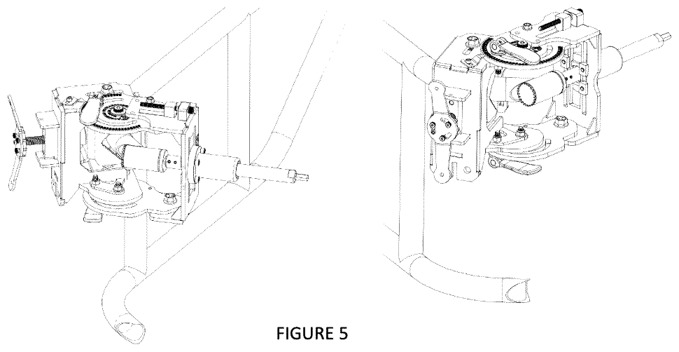

FIG. 5 represents the ability of the notcher to be used on an existing feedstock that may be too large to set on a bench or that may be fixed to an existing structure or other circumstances where the worker deems it necessary or practical to clamp the device into the feedstock directly.

1. A tube notcher with an adjustable and opposable clamping mechanism, comprising of a driven jaw that translates to clamp down on a feedstock to secure it against an opposing jaw wherein the opposing jaw can translate (and subsequently lock) in the same axis as the driven jaw, allowing the location of the centerline of the feedstock to be adjusted along the axis of the driven jaw:
a. Wherein the jaw of claim 1 has four points of contact with the object secured;
b. A profile wherein each jaw (opposable and static) have a 90-degree angle;
c. Wherein each jaw has incremented edges to further secure the feedstock;
d. Wherein the opposing jaw has hardware on opposing sides of feedstock such that 2 or more places are available to clamp the jaw into the frame;
e. Wherein the driven jaw is powered by an ACME thread type screw;
f. Wherein the driven jaw is able to penetrate the frame of the opposing jaw through holes cut into the opposing jaw frame (ref. 301) to allow a broader range of feedstock sizes to be clamped in a relatively small machine;
g. Wherein the driven and opposing jaw faces occupy different planes to allow them to translate past one another to facilitate clamping on a broad variety of feedstock sizes in a relatively small machine.
h. Wherein the handle (303) is removeable to allow greater workplace area.
i. Wherein 120 degrees of over travel allows the device to be fed from one side, ensuring worker safety compared to a machine that must be fed feedstock from multiple directions;
j. Wherein offset adjustment and angle scale increments are milled or laser etched into the frame for longevity of the device;
k. Wherein the opposing jaw in conjunction with offset adjustment allow notches to be made quickly and safely on preexisting bend feedstock.
l. Wherein the driveshaft (305) is outfitted with threads that allow any off the shelf hole saw to be used;
m. Wherein the cutting blade frame (304) is sufficiently long to allow various lengths of hole saws to be interchanged easily and quickly.

2. A tubing notcher comprising of a vise mechanism and pivoting cutting head that is equipped with one or more tension mechanism(s) that serve(s) to lift or lower the cutting head to be able to maintain a cutting axis orthogonal to the pivot axis of said cutting head:
a. The tensioner serves to remove sagging of a feedstock depending on the size and mass of said feedstock to maintain precise centerline alignment from cutting head to vice center;
b. Wherein the tensioning mechanism is positioned in line with the pivot axis where the vice half of machine and cutting half of machine meet;
c. Wherein the tensioning mechanism is a threaded fastener axially located in a block to enable it to both push and pull on the pivot axis from the point of fixation on the machine frame for greater adjustment accuracy and precision;
d. Wherein the axial friction surfaces of the tension adjuster (shown as a screw in FIG. 4, 411) are low friction bushings made of oil impregnated bronze alloy or other low friction material;
e. Wherein the cutting head (405) can accommodate various lengths of cutting bits in order to see the cut through in one pass;
f. Wherein the device can be clamped to existing feedstock that is immobile as the primary means of securing the tool during use.
